(19) United States
(12) Patent Application Publication
(10) Pub. No.: US 2026/0091656 A1
(43) Pub. Date: Apr. 2, 2026

(54) DRIVE SYSTEM PACKAGING FOR SLIDING WINDOW ASSEMBLY

(71) Applicant: Aisin Corporation, Kariya-Shi Aichi-Ken (JP)

(72) Inventors: Alexander P. Wells, New Hudson, MI (US); Glover A. Kosch, Ann Arbor, MI (US); Joel Thomas Runyan, Canton, MI (US); Michael A. Mixon, Brighton, MI (US)

(21) Appl. No.: 18/903,150

(22) Filed: Oct. 1, 2024

(51) Int. Cl. B60J 1/18; E05F 15/662

(52) U.S. Cl. CPC B60J 1/1853; E05F 15/662; E05Y 2900/55

(57) ABSTRACT

Embodiments described herein relate to window assemblies. In one embodiment, a window assembly includes a fixed panel defining a front side, a back side, and a perimeter having a top edge, a bottom edge opposite the top edge, a first side edge, and a second side edge opposite the first side edge. The window assembly also includes a moving panel that slides with respect to the fixed panel in a direction between the first side edge and the second side edge. The window assembly also includes a motor mounted to the fixed panel between the top edge and the bottom edge. The window assembly further includes drive components operable by the motor to slide the moving panel.

### TECHNICAL FIELD

The subject matter described herein relates, in general, to window assemblies and, more particularly, to sliding window assemblies for vehicles.

### BACKGROUND

Some vehicles include window assemblies that open and close in a sliding manner. To open and close the window, these assemblies can include motors that are electrically connected by wiring to various components of the assembly that slide the window. The motor and the wiring are packaged separately from the window assembly. In other words, the motor and the wiring are separated from the window and not connected together as in an arrangement when the window assembly is installed to the vehicle. Accordingly, when the window assembly is shipped, for example, from a supplier to an original equipment manufacturer (OEM), the OEM must install not only the window assembly, but also the motor and wiring, to the interior body of the vehicle. Packaging the motor and wiring separately from the window assembly creates two separate installation steps for the OEM, causing the OEM to spend more time installing the window assembly to the vehicle and creating more opportunity for error in both the shipping process and the installation process.

### SUMMARY

Example systems and other embodiments relate to drive system packaging for sliding window assemblies. As previously noted, some window assemblies suffer from various difficulties. For example, some window assemblies have motors and wiring packaged separately from the window. In such arrangements, when an installer installs the window assembly to a vehicle, the installer must also handle the motor and wiring, which increases the installation time and provides more opportunities for installation error. Thus, in at least one arrangement, a window assembly is provided that includes packaging a drive system of the window, including the motor and wiring, together with the remainder of the window assembly, into a single package that an installer can then install to the vehicle. Accordingly, the installer, for example, the OEM, is not required to perform a separate installation step, for example, mounting the motor to the vehicle or routing the drive components during installation.

In one embodiment, a window assembly includes a fixed panel defining a front side, a back side, and a perimeter having a top edge, a bottom edge opposite the top edge, a first side edge, and a second side edge opposite the first side edge. The window assembly also includes a moving panel that slides with respect to the fixed panel in a direction between the first side edge and the second side edge. The window assembly also includes a motor mounted to the fixed panel between the top edge and the bottom edge. The window assembly further includes drive components operable by the motor to slide the moving panel.

In another embodiment, a window assembly includes a fixed panel defining a front side, a back side, and a perimeter having a top edge, a bottom edge opposite the top edge, a first side edge, and a second side edge opposite the first side edge. The window assembly also includes a moving panel that slides with respect to the fixed panel in a direction between the first side edge and the second side edge. The window assembly also includes a motor housed in a motor housing that is adhered to the fixed panel between the top edge and the bottom edge. The window assembly further includes drive components including rails and cables. The cables are operable by the motor to slide the moving panel along the rails.

In yet another embodiment, a window assembly includes a fixed panel defining a front side, a back side, and a perimeter having a top edge, a bottom edge opposite the top edge, a first side edge, and a second side edge opposite the first side edge. The window assembly also includes a moving panel that moves with respect to the fixed panel in a direction between the first side edge and the second side edge. The moving panel and the fixed panel form a rear sliding window for a vehicle. The window assembly also includes a motor mounted to the fixed panel between the top edge and the bottom edge. The window assembly further includes drive components operable by the motor to move the moving panel. The window assembly has a shipping condition, in which the window assembly is shipped, and an install condition, in which the window assembly is installed to a vehicle. The shipping condition and the install condition are substantially identical.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one example of a front side of a window assembly for a vehicle.

FIG. 2A illustrates one example of a back side of a window assembly, in which the window assembly is in a closed state.

FIG. 2B illustrates one example of a back side of a window assembly, in which the window assembly is in an open state.

FIG. 3A illustrates one example of a cross-sectional view of a portion of a window assembly.

FIG. 3B illustrates one example of various components of a drive system for a window assembly.

### DETAILED DESCRIPTION

Various embodiments associated with a window assembly for a vehicle are disclosed. As previously noted, some window assemblies have motors and wiring packaged separately from the window. As a result, when an installer, such as an OEM, installs the window assembly to a vehicle, the installer must also handle the motor and wiring. This can increase the installation time and create more opportunities for installation error. Thus, in at least one arrangement, a window assembly is provided that packages a drive system of the window, including the motor, with the remainder of the window assembly, into a single package that an installer can then install to the vehicle. More specifically, in one arrangement, the window assembly includes an attachment indication located on a perimeter of the window and denoting where the window assembly is to be installed to the vehicle. In this arrangement, the drive system, including a motor, cables, and other components, is packaged with the remainder of the window assembly within the attachment indication. As a result, the installer can simply install the window assembly to the vehicle at the attachment indication without performing a separate installation step involving mounting the motor to the vehicle.

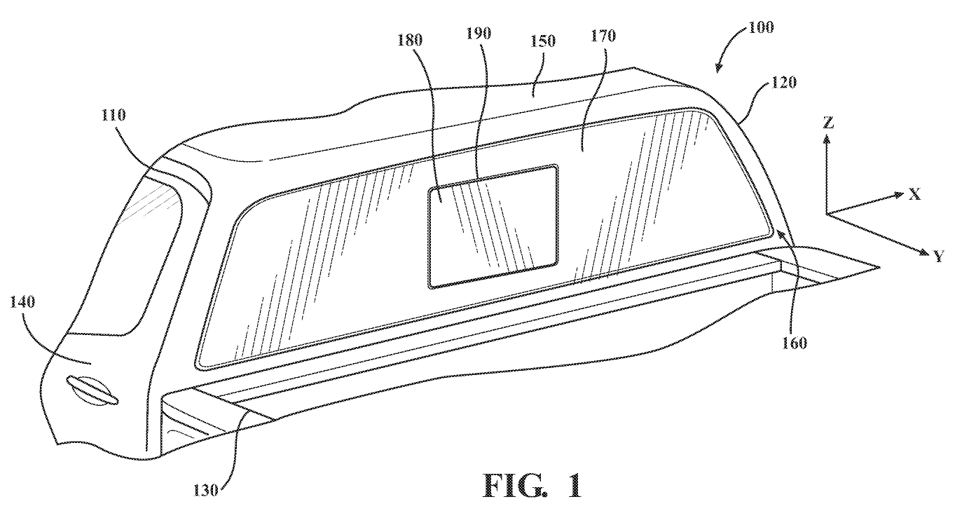

Referring now to FIG. 1, a portion of a vehicle 100 is shown. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of motorized transport that, for example, includes windows, and thus benefits from the functionality discussed herein associated with sliding window assemblies. As shown in FIG. 1, the vehicle 100 is a pickup truck with a driver side 110 and a passenger side 120. In instances in which the vehicle 100 is a left-hand drive vehicle 100, the driver side 110 is the side of the vehicle 100 on which the driver sits, and the passenger side 120 is the side of the vehicle 100 opposite the driver side 110. However, the driver side 110 and passenger side 120 may be flipped in another arrangement. Among other components of the pickup truck, the pickup truck includes a bed 130, a passenger compartment 140, a roof 150, and a window assembly 160. In one embodiment, for example, as shown, the window assembly 160 is a rear, sliding window assembly 160 for the pickup truck. As used herein, “rear” indicates that the window assembly 160 faces toward the bed 130. However, in other embodiments, the window assembly 160 is a side, sliding window assembly 160, for example, a window assembly 160 on the driver side 110 or passenger side 120.

The window assembly 160 includes one or more panels. In one embodiment, the panels are glass panels. In other embodiments, the panels are plexiglass, plastic, acrylic, or another material suitable for use as a window. In other words, the panels can be formed of a substantially clear and/or transparent material that closes off the passenger compartment 140 while allowing light to pass through and creating visibility out of the vehicle 100 for passengers within the vehicle 100. It should be understood that the panels can be formed of the same material, or the panels can be formed of different materials. Moreover, the panels are generally thin, planar components that are substantially flat or slightly curved.

In one implementation, for example, as shown in the figures, the window assembly 160 includes a fixed panel 170 and a moving panel 180. As used herein, “fixed” indicates that the fixed panel 170 does not substantially move with respect to the vehicle 100. In one arrangement, the fixed panel 170 is attached to the vehicle 100 and defines an opening 190. As shown, the opening 190 is located substantially centrally within the fixed panel 170. However, in other arrangements, the opening 190 can be located elsewhere with respect to the fixed panel 170 (e.g., the opening 190 can be located closer to one side of the vehicle 100 than another side of the vehicle 100).

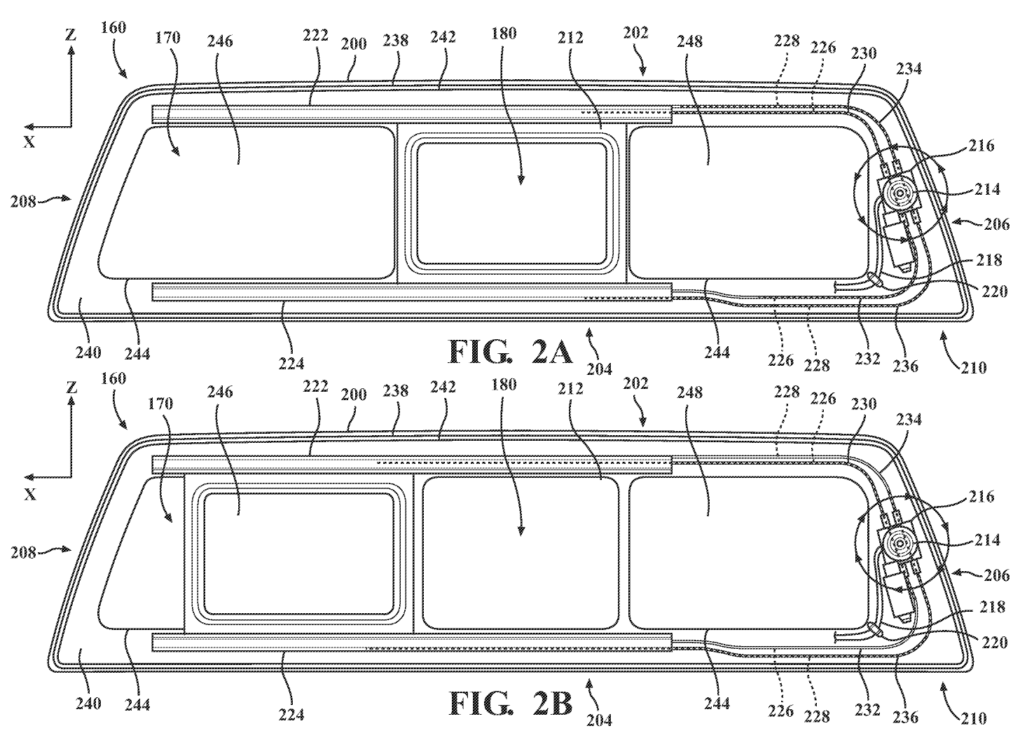

The moving panel 180, in one example, moves with respect to the fixed panel 170 to block and unblock the opening 190. In other words, the moving panel 180 moves to open and close the opening 190 of the window assembly 160. When the window assembly 160 is in a closed state, for example, as shown in FIGS. 1-2A, the moving panel 180 fully or substantially covers the opening 190 to block the opening 190 from air, water, and other environmental elements passing through the opening 190. When the window assembly 160 is in an open state, for example, as shown in FIG. 2B, the moving panel 180 does not substantially cover the opening 190, or the moving panel 180 completely unblocks the opening 190 to allow air, water, and other environmental elements to pass through the opening 190.

Referring back to the fixed panel 170, the fixed panel 170 defines a perimeter 200. The perimeter 200, in one example, is an edge of the fixed panel 170 substantially surrounding the fixed panel 170. In some instances, the fixed panel 170 is attached to the vehicle 100 at the perimeter 200. Moreover, in one arrangement, the perimeter 200 has a top edge 202, a bottom edge 204, a first side edge 206, a second side edge 208. In one arrangement, as described herein, the top edge 202 is located adjacent to the roof 150, and the bottom edge 204 is located opposite the top edge 202 (e.g., adjacent to the bed 130). Moreover, in one arrangement, as described herein, the first side edge 206 is located on the driver side 110, and the second side edge 208 is located opposite the first side edge 206 (e.g., on the passenger side 120). However, in other arrangements, the first side edge 206 can be located on the passenger side 120, and the second side edge 208 can be located on the driver side 110. The fixed panel 170 also defines a front side and a back side 210. As referred to herein, the front side is seen from outside of the vehicle 100 (e.g., the front side faces the bed 130), and the back side 210 is seen from the inside of the vehicle 100 (e.g., the back side 210 faces the passenger compartment 140). However, in other arrangements, the front side faces the passenger compartment 140, and the back side 210 faces the bed 130.

Referring back to the moving panel 180, as mentioned above, the moving panel 180 moves with respect to the fixed panel 170. As described in further detail below, in one embodiment, the moving panel 180 slides with respect to the fixed panel 170. More specifically, in one arrangement, the moving panel 180 slides in a direction of the first side edge 206 and the second side edge 208. In one example, the moving panel 180 moves from the opening 190 toward the first side edge 206 and back to the opening 190. In another example the moving panel 180 moves from the opening 190 toward the second side edge 208 and back to the opening 190. In other words, the moving panel 180 generally moves in a lateral direction of the vehicle 100 (e.g., substantially along the x-axis of FIG. 1). In some instances, the placement of the opening 190 within the fixed panel 170 and/or the direction of movement of the moving panel 180 are chosen by an original equipment manufacturer (OEM) of the vehicle 100. The OEM may choose these features based on the type of vehicle 100, the construction process of the vehicle 100, customer demands, and/or other factors.

Referring now to FIGS. 2A and 2B, the window assembly 160 includes, in one implementation, a frame 212 for the moving panel 180. The frame 212 houses the moving panel 180 and connects the moving panel 180 to the remainder of the window assembly 160. As described in further detail below, the frame 212 can help to facilitate movement of the moving panel 180. In one approach, the frame 212 is a plastic, injection molded part that substantially surrounds an edge of the moving panel 180. As such, the frame 212 not only facilitates movement of the moving panel 180, but also helps to protect the moving panel 180 from damage.

With continued reference to FIGS. 2A and 2B, in one arrangement, the window assembly 160 also includes a drive system. The drive system includes drive components that are operable to move the moving panel 180. More specifically, in one embodiment, the drive system interfaces with the moving panel 180, for example, via the frame 212, to slide the moving panel 180. The drive system includes, among other components described in further detail below, a motor 214, cables, and rails. In one arrangement, the moving panel 180 is supported by the rails, the cables are directly and/or indirectly connected to the moving panel 180, and the motor 214 operates the cables to slide the moving panel 180 along the rails. Each drive component as well as the operation of the drive system will be described in further detail below.

As shown in the figures, the motor 214 is mounted to the fixed panel 170. In one example, the motor 214 is adhered to the fixed panel 170. In another example, the motor 214 is located in a motor housing 216, and the motor housing 216 is attached to the fixed panel 170. The motor housing 216, in one embodiment, is attached to the fixed panel 170 by adhesive (in other words, the motor housing 216 is adhered to the fixed panel 170). The motor 214 can be attached to the motor housing 216 by threaded fasteners, in one example. The motor 214 (and likewise, the motor housing 216), is attached to the fixed panel 170 between the top edge 202 and the bottom edge 204. As shown, the motor 214 is mounted to the fixed panel 170 substantially equidistant to the top edge 202 and the bottom edge 204. However, in other arrangements, the motor 214 can be mounted to the fixed panel 170 closer to one of the top edge 202 and the bottom edge 204. Moreover, in some instances, the motor 214 is mounted to the fixed panel 170 adjacent to one of the first side edge 206 and the second side edge 208. More specifically, the motor 214 can be mounted to the fixed panel 170 about a few inches offset from the first side edge 206 or the second side edge 208. As shown in the figures, the motor 214 is mounted to the fixed panel 170 adjacent to the first side edge 206.

To provide power to the motor 214 once the window assembly 160 is installed to the vehicle 100, the window assembly 160 also includes, in one arrangement, a wire harness 218. The wire harness 218, in one example, is attached to the motor 214 and is configured to attach to the vehicle 100 to electrically connect the motor 214 to the vehicle 100. In one embodiment, the wire harness 218, before installation to the vehicle 100, is attached to the fixed panel 170. For example, the wire harness 218 can be attached to the fixed panel 170 with a clip 220 or another fastener before the window assembly 160 is installed to the vehicle 100. Other methods of attaching the wire harness 218 to the fixed panel 170 include adhesion, tape, etc. Further details of the attachment of the wire harness 218 to the fixed panel 170 will be described in further detail below.

Referring now to the rails, in one embodiment, the window assembly 160 includes a top rail 222 and a bottom rail 224. As shown, the top rail 222 is located adjacent to the top edge 202, and the bottom rail 224 is located adjacent to the bottom edge 204. The rails 222/224 are attached to the back side 210 of the fixed panel 170, for example, by adhesion. The rails 222/224 extend along the top edge 202 and the bottom edge 204 substantially along the x-axis. In one arrangement, for example, as shown, the rails 222/224 span a portion of the top edge 202 and the bottom edge 204. The rails 222/224 can be formed of metal, plastic, or another material with suitable rigidity to support the moving panel 180 as the moving panel 180 slides along the rails 222/224. Moreover, the rails 222/224 can be substantially identical in one or more aspects (e.g., in length, size, material, etc.), or the top rail 222 and the bottom rail 224 can be different in one or more aspects.

Referring now to the cables, in one embodiment, the window assembly 160 includes a top cable 226 and a bottom cable 228. In the arrangement shown, the top cable 226 is disposed within the top rail 222, and the bottom cable 228 is disposed within the bottom rail 224. Moreover, in one implementation, the top cable 226 is located closer to a central area of the fixed panel 170, while the bottom cable 228 is located closer to the perimeter 200. However, in other arrangements, the top cable 226 can be located closer to the perimeter 200, and the bottom cable 228 can be located closer to the central area of the fixed panel 170. In either case, the cables 226/228 are connected to the motor 214 and the moving panel 180 and are operable by the motor 214 to slide the moving panel 180 along the rails 222/224. More specifically, in one arrangement, the cables 226/228 are connected to the motor 214 and to the frame 212. In one example, the cables 226/228 define grooves, and the motor 214 includes a toothed drive gear that drives the cables 226/228 by the grooves. However, the motor 214 and the cables 226/228 can interface in other manners as well. Additionally, in one arrangement, the motor 214 rotates clockwise and/or counterclockwise to operate the cables 226/228 in a push-pull manner to slide the moving panel 180. Referring now to FIGS. 2A and 2B, operating the motor 214 in a pushing manner slides the moving panel 180 toward the first side edge 206 to unblock the opening 190, while operating the motor 214 in a pulling manner slides the moving panel 180 toward the opening 190. However, it should be understood that the push-pull manner can be reversed. For example, in another arrangement, operating the motor 214 in a pulling manner slides the moving panel 180 toward the first side edge 206 to unblock the opening 190, while operating the motor 214 in a pushing manner slides the moving panel 180 toward the opening 190. The direction of the push-pull operation may be decided by the OEM.

The cables, in one embodiment, extend toward the rails 222/224 substantially following the perimeter 200 and offset from the perimeter 200. As such, the cables 226/228 generally follow the perimeter 200 so that the cables 226/228 do not substantially interfere with the viewing area through the fixed panel 170 and do not interfere with the attachment of the fixed panel 170 to the vehicle 100, as described in further detail below. In some instances, the cables 226/228 are generally flexible, and accordingly, the cables 226/228 need to be directed to follow the paths shown in the figures. As such, in one embodiment, the window assembly 160 can include tubes. The tubes can house the cables 226/228 and direct the cables 226/228 from the motor housing 216 to the rails 222/224. In one example, the window assembly 160 includes a first tube 230, a second tube 232, a third tube 234, and a fourth tube 236. As shown, the first tube 230 houses a portion of the top cable 226, the second tube 232 houses the remainder of the top cable 226, the third tube 234 houses a portion of the bottom cable 228, and the fourth tube 236 houses the remainder of the bottom cable 228. However, it should be understood that the tubes 230-234 can house the cables 226/228 in other manners. In any case, the tubes 230-234 can be substantially rigid and hollow such that the tubes 230-234 place the cables 226/228 in the arrangements shown in the figures while the cables 226/228 can slide within the tubes 230-234. More specifically, in one arrangement, the tubes 230-234 extend between the motor housing 216 and the rails 222/224, following the perimeter 200 and offset from the perimeter 200. Moreover, as mentioned above, the motor 214 can be housed in a motor housing 216. Accordingly, in one implementation, the cables 226/228 are configured to pass through the motor housing 216 such that the cables 226/228 can contact the motor 214. Accordingly, the cables 226/228 extend from the rails 222/224, through the tubes 230-234, and into the motor housing 216.

As mentioned above, the window assembly 160 is configured for installment to the vehicle 100. In some instances, the window assembly 160 is manufactured by a supplier and shipped to the OEM, who installs the window assembly 160 to the vehicle 100. Accordingly, the window assembly 160 has a shipping condition and an install condition. In the shipping condition, the window assembly 160 is substantially ready for shipping, is actively being shipped, and/or has already been shipped. Likewise, in the install condition, the window assembly 160 is substantially ready for installation, is actively being installed to the vehicle 100, or is installed to the vehicle 100. The arrangements described herein advantageously allow the shipping condition and the install condition of the window assembly 160 to be substantially identical. As a result, upon receipt of the window assembly 160, the installer does not need to handle the drive system components and/or perform pre-installation steps in order to install the window assembly 160 to the vehicle 100. Thus, during installation of the window assembly 160, the installer performs fewer steps to install the window assembly 160, thereby decreasing the opportunity for errors during installation and increasing the efficiency of the installation.

As mentioned above, the shipping condition and the install condition are substantially identical. Accordingly, the placement of the drive system components on the fixed panel 170 as shown in the figures is substantially identical in both the shipping condition and the install condition. More specifically, in one arrangement, the drive components, including the rails 222/224, cables 226/228, motor 214, and/or the motor housing 216, are attached to the fixed panel 170 in the same locations in both the shipping condition and the install condition.

In one approach, the window assembly 160 is installed to the vehicle 100 using adhesive. For example, the vehicle 100 includes a body flange, and the window assembly 160 is adhered to the body flange. The body flange can have a size and shape substantially similar to the perimeter 200 of the window assembly 160 such that the window assembly 160, when installed to the vehicle 100, substantially closes the passenger compartment 140 via the body flange. In some implementations, accordingly, the window assembly 160 includes an attachment indication 238. The attachment indication 238 is a guide that denotes where on the fixed panel 170 the window assembly 160 is to be attached to the vehicle 100 during installation. For example, the attachment indication 238 can be a line that indicates the placement of the adhesive on the back side 210 of the fixed panel 170 that joins the fixed panel 170, and thus the window assembly 160, to the body flange. In other words, in one implementation, the attachment indication 238 substantially aligns with a body flange of the vehicle 100 such that the fixed panel 170 is adhered to the body flange during installation. The attachment indication 238, in one arrangement, is offset from the perimeter 200 and substantially follows the perimeter 200. In some instances, the attachment indication 238 is essentially an imaginary line. In other words, there is no marking or physical structure on the fixed panel 170 that denotes where the adhesive is to be placed. This may be because the adhesive is placed by a robot that knows where to deposit the adhesive. In other instances, the attachment indication 238 is a mark, etch, or another physical line, which may be useful to a human worker who places the adhesive on the fixed panel 170. Further, in one arrangement, the attachment indication 238 can be limited to one or more corners of the fixed panel 170 (e.g., the attachment indication 238 can be dots or marks on the corners of the fixed panel 170).

In either case, the attachment indication 238, in one embodiment, substantially or completely encircles the drive system components, including the rails 222/224, cables 226/228, motor 214, and motor housing 216. In other words, in one embodiment, the drive components are provided on (e.g., adhered to) the fixed panel 170 within the attachment indication 238. The drive components and the motor 214 can thus be provided on the fixed panel 170 within the attachment indication 238 in both the shipping condition and the install condition. As such, the drive system is packaged together with the remainder of the window assembly 160 within the attachment indication 238. In some instances, all of the components of the drive system are adhered to the fixed panel 170 within the attachment indication 238.

It should be noted that in the shipping condition, the wire harness 218 is also located within an inside area defined by the attachment indication 238. As described above, the wire harness 218 can be clipped to the fixed panel 170 in the shipping condition so that all of the components of the window assembly 160 are located within the attachment indication 238, which may facilitate shipping of the window assembly 160 as all of the components are packaged together. Moreover, as noted above, the shipping condition and the install condition are substantially identical. One of the only differences between the shipping condition and the install condition is that, when the window assembly 160 is installed to the vehicle 100, the installer needs to attach the wire harness 218 to the vehicle 100. Accordingly, the wire harness 218 may cross over the attachment indication 238 if the connection between the wire harness 218 and the vehicle 100 is outside of the attachment indication 238. Otherwise, the remainder of the components of the window assembly 160 are located within the attachment indication 238. As a result, the installer does not have to handle the motor 214 or the cables 226/228 during installation.

Moreover, while the window assembly 160 is described herein as being connected to the vehicle 100 along the attachment indication 238 with adhesive, it should be understood that the adhesive is merely one example of attaching the window assembly 160 to the vehicle 100. In other examples, the window assembly 160 can be mounted to the vehicle 100 using fasteners such as bolts or screws, or the window assembly 160 can even be welded to the vehicle 100. As such, the attachment indication 238 does not need to be a line that indicates placement of adhesive. In fact, in other arrangements, the window assembly 160 can have, in place of an attachment indication 238, a line, marker, or other physicality that denotes where the window assembly 160 is to be mounted to the vehicle 100. For example, the window assembly 160 can include fastener placement markers, fastener apertures, a welding marking line, etc.

With continued reference to FIGS. 2A-2B, in some arrangements, the window assembly 160 includes a cover 240. The cover 240 is configured to substantially block light from passing through the fixed panel 170. In other words, the cover 240 is made of a material that substantially blocks viewing through the fixed panel 170 by an occupant of the vehicle 100 or by a person standing outside the vehicle 100. In greater detail, the cover 240 defines cover edges including, for example, an outer cover edge 242 and one or more inner cover edges 244. The configuration of the cover edges 242/244 dictates visibility through the window. For example, as shown in FIGS. 2A-2B, the cover 240 defines two inner cover edges 244 that divide the visibility of the fixed panel 170 into two sections, as described in further detail below. Moreover, in one implementation, the outer cover edge 242 generally follows the perimeter 200 and is offset from the perimeter 200.

The cover 240, in one implementation, is attached to the back side 210 of the fixed panel 170. When attached to the back side 210, in one embodiment, the cover 240 is attached to the back side 210 underneath the drive system (e.g., between the back side 210 and the drive components, including the motor 214, cables 226/228, and rails 222/224). However, in other arrangements, the cover 240 can be attached to the front side of the fixed panel 170. Moreover, the cover 240 is attached to the fixed panel 170, for example, by adhesive. In some instances, the cover 240 is a film that is applied to the fixed panel 170, for example, a ceramic film. However, the cover 240 can be made of other materials as well. As described in further detail below, the cover 240 advantageously serves various purposes when utilized within the window assembly 160.

In one example, the cover 240 substantially blocks viewing of the motor 214 and/or the drive components through the front side. As a result, the motor 214 can be placed on the fixed glass between the top rail 222 and the bottom rail 224, and a person standing outside of the vehicle 100 would not be able to see the motor 214. Additionally, in a similar manner, the cover 240 can block viewing of the remainder of the drive components. For example, the inner cover edge 244 can be located further toward the center of the fixed panel 170 than the rails 222/224 and cables 226/228. As such, the cover 240 substantially blocks visibility of the rails 222/224 and cables 226/228 from the outside of the vehicle 100. As a result, the cover 240 advantageously improves the aesthetic appearance of the window assembly 160. In a similar way, in another example, the cover 240 also defines a motor packaging space within which the motor 214 is mounted to the fixed panel 170. The motor packaging space is, in one implementation, an area between the inner cover edges 244 and the outer cover edge 242 and/or the perimeter 200. As shown, the motor packaging space is thus adjacent to the second side edge 208 of the fixed panel 170. However, it should be understood that, in another implementation, the motor packaging space can be adjacent to the first side edge 206. The motor packaging space advantageously allows the motor 214 (and the remainder of the drive components) to be mounted to the fixed panel 170 in a final installed condition to the vehicle 100 without the motor 214 being visible from outside the vehicle 100. This will be described in further detail below.

In yet another example, the cover 240 not only defines the motor packaging space on one side of the fixed panel 170, but also allows for increased visibility on the other side of the fixed panel 170. For example, as shown, the inner cover edges 244 can divide the viewing area of the fixed panel 170 into at least two sections (e.g., separate windows). In one implementation, the inner cover edges 244 divide the viewing area into a substantially trapezoidal window 246 and a substantially rectangular window 248. The trapezoidal window 246 is located adjacent to the first side edge 206, and the rectangular window 248 is located adjacent to the second side edge 208. However, in another arrangement, the trapezoidal window 246 can be located adjacent to the second side edge 208, and the rectangular window 248 can be located adjacent to the first side edge 206. In either case, as a result of the shape of the rectangular window 248, an area between the rectangular window 248 and the first side edge 206 or the second side edge 208 creates the motor packaging space. Additionally, as a result of the shape of the trapezoidal window 246, the trapezoidal window 246 has a greater visibility through the fixed panel 170 than the rectangular window 248. As a result, the rectangular window 248 and the trapezoidal window 246 advantageously function together to maintain visibility through the fixed panel 170 while also creating the motor packaging space.

In some instances, the rectangular window 248 is located on the driver side 110 of the vehicle 100, and the trapezoidal window 246 is located on the passenger side 120 of the vehicle 100. Placing the rectangular window 248, and thus the motor packaging space, on the driver side 110, can improve the aesthetic appearance of the window assembly 160 from within the passenger compartment 140. For example, a driver of the vehicle 100 typically does not look in a direction straight behind the driver seat, and so the driver would not typically see the motor 214 mounted to the fixed panel 170. However, the driver may often look over his or her shoulder to see through the fixed panel 170 on the passenger side 120, for example, while reversing the vehicle 100. Accordingly, providing the trapezoidal window 246 on the passenger side 120 allows the driver to maintain significant visibility through the fixed panel 170 on the passenger side 120. While configuring the window assembly 160 in this manner provides many advantages, it should be understood that the window assembly 160 can also be configured in an opposite manner, with the rectangular window 248, and thus the motor packaging space, on the passenger side 120 and with the trapezoidal window 246 on the driver side 110.

In any case, enhanced aesthetic appearance of the window assembly 160 from within the passenger compartment 140 can be achieved in other ways as well. In one approach, the motor 214 can be further hidden from view by a C-pillar garnish of the vehicle 100, which can be located on the driver side 110 and/or the passenger side 120. The other drive components can be hidden from view as well. For example, the bottom rail 224 and/or the bottom cable 228 can be hidden from view by one or more seats of the vehicle 100, for example, the back seats of the vehicle 100. The back seats, for example, the headrests of the back seats, can overlap the bottom edge 204 of the fixed panel 170 to substantially block the bottom rail 224 and/or bottom cable 228 from view by a person within the passenger compartment 140. Moreover, in some instances, the top rail 222 and/or top cable 226 may be exposed within the passenger compartment 140 and within view of a person within the passenger compartment 140.

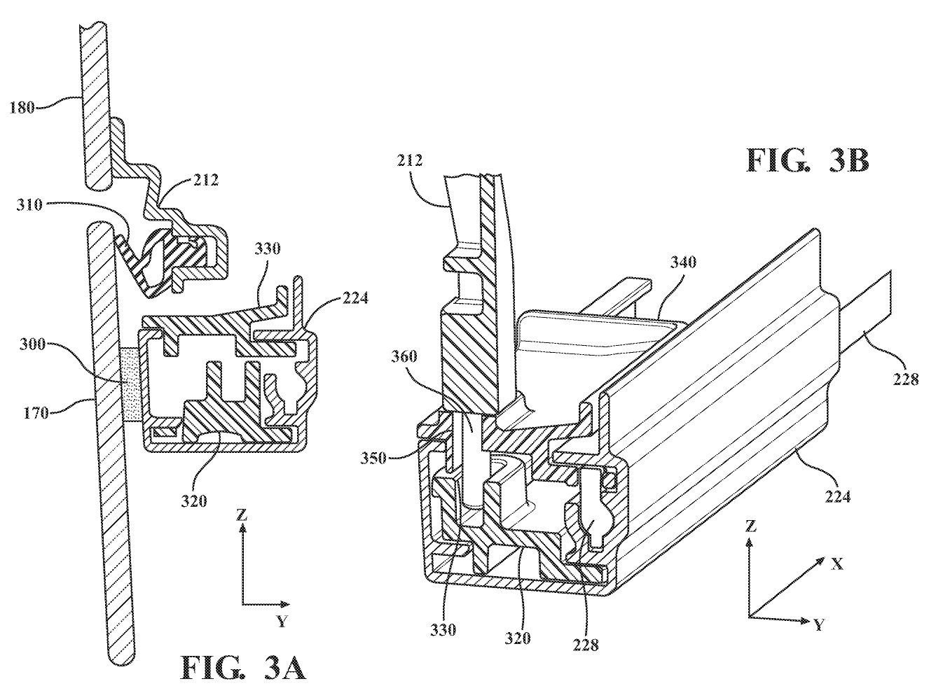

Referring now to FIGS. 3A and 3B, further details of the window assembly 160 will now be described. FIG. 3A shows a side, cross-sectional view along the bottom rail 224, while FIG. 3A shows a perspective view of various components of the drive system. FIG. 3A illustrates one example of an adhesive 300 that attaches the bottom rail 224 to the fixed panel 170. It should be understood that the top rail 222 can be attached to the fixed panel 170 in a similar manner. FIG. 3A also illustrates one example of a weatherstrip 310 for the window assembly 160. The weatherstrip 310 is, in one implementation, attached to the frame 212. As such, when the moving panel 180 moves to the closed state to block the opening 190, the weatherstrip 310 substantially seals the gap between the frame 212 and the opening 190, thus substantially preventing air, water, and other environmental elements from entering the vehicle 100 through the opening 190. Finally, among the other components shown in FIG. 3A, FIG. 3A also illustrates one example of a guide 320 and a shoe 340 for the drive system. In one arrangement, the guide 320 provided on the rail and includes grooves 330 that direct the movement of the moving panel 180 along the rail. Further, in one arrangement, the shoe 340 is provided on the guide 320 and the bottom rail 224 and is operable by the bottom cable 228 to move the moving panel 180. More specifically, in one arrangement, the moving panel 180 is disposed within the shoe 340 such that, when the bottom cable 228 is operated by the motor 214, the bottom cable 228 slides the shoe 340 along the rail, thus sliding the moving panel 180 as well. This will be described in further detail below in connection with FIG. 3B.

Referring now to FIG. 3B, in one arrangement, the window assembly 160 includes pins 360 that connect the frame 212 to the drive system. An exemplary pin is shown in FIG. 3B. As shown, the pin 360 is received at one end by the frame 212 and at the other end by the groove 330 of the guide 320. Moreover, the pin 360 extends through an aperture 350 of the shoe 340. The frame 212 can include another pin 360 arranged in a similar manner at another end of the frame 212. Accordingly, when the bottom cable 228 is operated by the motor 214 in a push-pull manner, the bottom cable 228 slides the shoe 340 along the bottom rail 224, thus sliding the frame 212 and the moving panel 180 along the bottom rail 224. As the frame 212 and moving panel 180 slide along the bottom rail 224, the grooves 330 direct the movement of both components via the pins 360. While FIG. 3B is described with reference to the bottom rail 224 and the bottom cable 228, it should be understood that the description of FIG. 3B can equally apply to the top rail 222 and the top cable 226. For example, the window assembly 160 can also include a guide 320, a shoe 340, and pins 360 that interface with the top rail 222 and top cable 226 to push and pull the moving panel 180 along the top rail 222.

It should be understood that, in one arrangement, the drive system also includes the additional components shown in FIGS. 3A and 3B, for example, the guide 320, the shoe 340, and the pins 360. Accordingly, the guide 320, the shoe 340, and the pins 360 can also be packaged within the attachment indication 238 in both the shipping condition and the install condition.

The arrangements described herein provide the advantage of streamlining the installation process of a window assembly to a vehicle. For example, the arrangements described herein provide a drive system packaging for a window assembly that does not require an installer to handle a motor of the window assembly. As a result, installation of the window assembly to the vehicle is more efficient and less prone to error. In another example, the arrangements described herein provide the benefit of improving the aesthetic appearance of a window assembly in various ways. In one way, the window assembly includes a cover that blocks visibility of various drive components of the window assembly from outside the vehicle. In another way, the vehicle includes components such as a C-pillar garnish or back rear seats that block visibility of some of the drive components from within the vehicle.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-3B, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of… and…,” as used herein, refers to and encompasses any and all possible combinations of one or more of the associated listed items. As an example, the phrase “at least one of A, B, and C” includes A only, B only, C only, or any combination thereof (e.g., AB, AC, BC, OR ABC).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some examples, “substantially” can include being within normal manufacturing tolerances.

In this description, uses of “front,” “forward” and the like, and uses of “rear,” “rearward” and the like, refer to the longitudinal directions of the vehicle. “Front,” “forward,” and the like refer to the front (fore) of the vehicle, while “rear,” “rearward” and the like refer to the back (aft) of the vehicle. Uses of “side,” “sideways,” “transverse” and the like refer to the lateral directions of the vehicle, with “driver’s side” and the like referring to the left side of the vehicle, and “passenger side” and the like referring to the right side of the vehicle.

Aspects herein can be embodied in other forms without departing from the spirit or essential attributes thereof. Accordingly, reference should be made to the following claims, rather than to the foregoing specification, as indicating the scope thereof.

What is claimed is:

1. A window assembly, comprising:
a fixed panel defining a front side, a back side, and a perimeter having a top edge, a bottom edge opposite the top edge, a first side edge, and a second side edge opposite the first side edge;
a moving panel that slides with respect to the fixed panel in a direction between the first side edge and the second side edge;
a motor mounted to the fixed panel between the top edge and the bottom edge; and
drive components operable by the motor to slide the moving panel.

2. The window assembly of claim 1, wherein the drive components include:
rails attached to the back side, the rails including a top rail adjacent to the top edge and a bottom rail adjacent to the bottom edge, wherein the moving panel slides along the rails; and
cables connected to the motor and the moving panel, the cables including a top cable disposed within the top rail and a bottom cable disposed within the bottom rail, wherein the motor operates the cables in a push-pull manner to slide the moving panel along the rails.

3. The window assembly of claim 2, wherein the cables pass through the motor housing and extend toward the rails substantially following the perimeter and offset from the perimeter.

4. The window assembly of claim 1, further comprising a cover attached to the back side between the fixed panel and the motor, wherein the cover substantially blocks viewing of at least one of the motor and the drive components through the front side.

5. The window assembly of claim 1, further comprising a cover that blocks visibility through a portion of the fixed panel, wherein the cover defines a cover edge offset from the perimeter, and wherein an area between the cover edge and at least one of the first side edge and the second side edge defines a packaging space for the motor to be mounted to the fixed panel.

6. The window assembly of claim 1, wherein the fixed panel and the moving panel form a rear sliding window for a vehicle, and further comprising a cover that divides a viewing area of the fixed panel into at least one rectangular window and one trapezoidal window, wherein an area between the rectangular window and one of the first side edge and the second side edge creates packaging space for the motor to be mounted to the fixed panel, and wherein the trapezoidal window is on a passenger side of the vehicle for increased visibility, for a driver of the vehicle, through the fixed panel.

7. The window assembly of claim 1, further comprising an attachment indication on the back side substantially following the perimeter and offset from the perimeter, wherein the window assembly is shipped with the motor and drive components provided on the fixed panel within the attachment indication.

8. A window assembly, comprising:
a fixed panel defining a front side, a back side, and a perimeter having a top edge, a bottom edge opposite the top edge, a first side edge, and a second side edge opposite the first side edge;
a moving panel that slides with respect to the fixed panel in a direction between the first side edge and the second side edge;
a motor housed in a motor housing that is adhered to the fixed panel between the top edge and the bottom edge; and
drive components including rails and cables, the cables being operable by the motor to slide the moving panel along the rails.

9. The window assembly of claim 8, wherein the rails are attached the back side and include a top rail adjacent to the top edge and a bottom rail adjacent to the bottom edge, wherein the moving panel is supported within the rails, and
wherein the cables are attached to the motor and the moving panel and include a top cable disposed within the top rail and a bottom cable disposed within the bottom rail, wherein the motor operates the cables in a push-pull manner to slide the moving panel along the rails.

10. The window assembly of claim 8, further comprising substantially rigid tubes that house the cables and that extend between the motor housing and the rails, following the perimeter and offset from the perimeter.

11. The window assembly of claim 8, further comprising a cover attached to the back side between the fixed panel and the motor, wherein the cover substantially blocks viewing of at least one of the motor and the drive components through the front side, and wherein the cover is a ceramic film.

12. The window assembly of claim 8, further comprising a cover that blocks visibility through a portion of the fixed panel, wherein the cover defines a cover edge offset from the perimeter, and wherein an area between the cover edge and at least one of the first side edge and the second side edge defines a packaging space for the motor to be mounted to the fixed panel.

13. The window assembly of claim 8, further comprising an attachment indication on the back side substantially following the perimeter and offset from the perimeter, wherein the window assembly is shipped with the motor and drive components disposed on the fixed panel within the attachment indication.

14. A window assembly, comprising:
a fixed panel defining a front side, a back side, and a perimeter having a top edge, a bottom edge opposite the top edge, a first side edge, and a second side edge opposite the first side edge;
a moving panel that moves with respect to the fixed panel in a direction between the first side edge and the second side edge, the moving panel and the fixed panel forming a rear sliding window for a vehicle;
a motor mounted to the fixed panel between the top edge and the bottom edge; and
drive components operable by the motor to move the moving panel, wherein the window assembly has a shipping condition, in which the window assembly is shipped, and an install condition, in which the window assembly is installed to a vehicle, wherein the shipping condition and the install condition are substantially identical.

15. The window assembly of claim 14, wherein, in the shipping condition and the install condition, the motor and the drive components are provided on the fixed panel within an attachment indication that is located on the back side, substantially follows the perimeter, and is offset from the perimeter.

16. The window assembly of claim 15, wherein the attachment indication is a guide for placing adhesive on the fixed panel, and wherein the attachment indication substantially aligns with a body flange of the vehicle such that the fixed panel is adhered to the body flange during installation.

17. The window assembly of claim 14, wherein the install condition does not require an installer to handle the motor or route the drive components during installation of the window assembly to the vehicle.

18. The window assembly of claim 14, further comprising a wire harness that electrically connects the motor to the vehicle, wherein the wire harness is attached to the fixed panel within the perimeter in the shipping condition.

19. The window assembly of claim 14, wherein, when the fixed panel is installed to the vehicle, the motor is substantially hidden from a view of an occupant of the vehicle by a C-pillar garnish of the vehicle.

20. The window assembly of claim 14, wherein the drive components include:
a rail attached to the back side adjacent to the bottom edge, wherein the moving panel is mounted within the rail; and
a cable attached to the motor and the moving panel adjacent to the bottom edge, wherein the motor operates the cable to slide the moving panel along the rail, wherein the rail and the cable are substantially hidden from a view of an occupant of the vehicle by one or more rear seats of the vehicle.
